(19) United States
(12) Patent Application Publication
(10) Pub. No.: US 2022/0374475 A1
(43) Pub. Date: Nov. 24, 2022

(54) System and Method for Predicting Future Player Performance in Sport

(71) Applicant: STATS LLC, Chicago, IL (US)

(72) Inventors: Daniel Richard Dinsdale, London (GB); Joe Dominic Gallagher, Wirral (GB); Paul David Power, Leeds (GB)

(73) Assignee: STATS LLC, Chicago, IL (US)

(21) Appl. No.: 17/663,921

(22) Filed: May 18, 2022

Related U.S. Application Data
(60) Provisional application No. 63/201,898, filed on May 18, 2021.
(60) Provisional application No. 63/267,062, filed on Jan. 24, 2022.

(51) Int. Cl. G06F 16/9035; G06F 16/908; G06N 3/04

(52) U.S. Cl. CPC G06F 16/9035; G06F 16/908; G06N 3/0454

(57) ABSTRACT

A computing system receives a request to project a performance of a first player from a current team on a destination team. The computing system generates, based on the request, player-position features corresponding to the first player. The computing system generates team features corresponding to the first player. The computing system generates rating features for the first player. The computing system generates, via a prediction model, a player box score prediction based on the player-position features, the team features, and the rating features. The player box score prediction includes a plurality of per game metrics of the first player on the destination team.

### CROSS-REFERENCE TO RELATED APPLICATIONS

This application claims priority to U.S. Provisional Application Ser. No. 63/201,898, filed May 18, 2021, and to U.S. Provisional Application Ser. No. 63/267,062, filed Jan. 24, 2022, which are hereby incorporated by reference in their entireties.

### FIELD OF THE DISCLOSURE

The present disclosure generally relates to system and method for predicting player performance on a proposed destination team.

### BACKGROUND

Professional sports commentators and fans alike typically engage in what-if scenarios for players. For example, a common thread in sports media focuses on how a player would perform if traded to or acquired by a certain destination team.

### SUMMARY

In some embodiments, a method is disclosed herein. A computing system receives a request to project a performance of a first player from a current team on a destination team. The computing system generates, based on the request, player-position features corresponding to the first player. The player-position features include a rolling average of historical player performance data of the first player while playing a first position. The computing system generates team features corresponding to the first player. The team features include a first rolling average of historical team performance data of the current team and a second rolling average of historical team performance data of the destination team. The computing system generates rating features for the first player. The rating features include a first rolling average of team-league rating features for the current team and a current league corresponding to the current team and second rolling average of team-league rating features for the destination team and a destination league corresponding to the destination team. The computing system generates, via a prediction model, a player box score prediction based on the player-position features, the team features, and the rating features. The player box score prediction includes a plurality of per game metrics of the first player on the destination team.

In some embodiments, a non-transitory computer readable medium is disclosed herein. The non-transitory computer readable medium includes a sequence of instructions, which, when executed by a processor, causes a computing system to perform operations. The operations include receiving, by the computing system, a request to project a performance of a first player from a current team on a destination team. The operations further include, based on the request, generating, by the computing system, player-position features corresponding to the first player. The player-position features include a rolling average of historical player performance data of the first player while playing a first position. The operations further include generating, by the computing system, team features corresponding to the first player. The team features include a first rolling average of historical team performance data of the current team and a second rolling average of historical team performance data of the destination team. The operations further include generating, by the computing system, rating features for the first player. The rating features include a first rolling average of team-league rating features for the current team and a current league corresponding to the current team and second rolling average of team-league rating features for the destination team and a destination league corresponding to the destination team. The operations further include generating, by the computing system via a prediction model, a player box score prediction based on the player-position features, the team features, and the rating features. The player box score prediction includes a plurality of per game metrics of the first player on the destination team.

In some embodiments, a system is disclosed herein. The system includes a processor and a memory. The memory has programming instructions stored thereon, which, when executed by the processor, causes the processor to perform operations. The operations include receiving a request to project a performance of a first player from a current team on a destination team. The operations further include, based on the request, generating player-position features corresponding to the first player. The player-position features include a rolling average of historical player performance data of the first player while playing a first position. The operations further include generating team features corresponding to the first player. The team features include a first rolling average of historical team performance data of the current team and a second rolling average of historical team performance data of the destination team. The operations further include generating rating features for the first player. The rating features include a first rolling average of team-league rating features for the current team and a current league corresponding to the current team and second rolling average of team-league rating features for the destination team and a destination league corresponding to the destination team. The operations further include generating, via a prediction model, a player box score prediction based on the player-position features, the team features, and the rating features. The player box score prediction includes a plurality of per game metrics of the first player on the destination team.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating transfer portal, according to example embodiments.

FIG. 3 is a block diagram illustrating raw feature module generating one or more features on a per-game level at various levels, according to example embodiments.

FIG. 4 is a block diagram illustrating adjustment module adjusting game-by-game team-level features, according to example embodiments.

FIG. 5 is a block diagram illustrating adjustment module adjusting game-by-game player-level features, according to example embodiments.

FIG. 6 is a block diagram illustrating team and league Ratings module creating ratings features, according to example embodiments.

FIG. 7 is a block diagram illustrating a model architecture of prediction model, according to example embodiments.

FIG. 8 is a block diagram illustrating a method for generating player-level box score predictions, according to exemplary embodiments.

FIG. 9A is a block diagram illustrating a training data structure for adjustment module, according to example embodiments.

FIG. 9B is a block diagram illustrating a training data structure for adjustment module, according to example embodiments.

FIG. 10 is a flow diagram illustrating a method of generating a player transfer prediction, according to example embodiments.

FIG. 11 illustrates an example shortlist generated by transfer portal, according to example embodiments.

FIG. 12A is a block diagram illustrating a computing device, according to example embodiments.

FIG. 12B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Deadline day is one of the biggest occasions in the soccer calendar. Deadline day is the final opportunity for teams to sign players in the trading window before it is closed for the first half of the season. Deadline day is not unique to soccer, however. As those skilled in the art understand, various sports leagues, such as, but not limited to, English Premier League, National Hockey League, National Football League, National Basketball Association, and Major League Baseball all have deadlines by which trades must be made, i.e., “trade deadlines.”

As a team owner, manager, or transfer committee looking to improve the fortunes of their team on deadline day, these important and time-dependent decisions rely on player scouting to determine potential signings who fit their team's playing style and budget. The scouting process generally combines data appraisal on performance metrics with direct observations of players via video and/or match attendance to make critical business decisions on which players represent best value for money. This is because, in addition to being the most valuable prediction a team makes, it is also the most complex analytics task to perform due to the various factors that may need to be considered. For example, team owner, manager, or transfer committee may consider one or more of (a) the difference in playing style between the player's current and target team; (b) the difference in teammate ability; (c) the difference in league quality and style; and (d) the role the player is desired to play. This process may involve a substantial time investment, which, with a rapidly changing market, is often not viable or flexible enough to make informed decisions on the fly.

One or more techniques described herein provide an improvement over the conventional approach of projecting player performance when transferred from a first team to a second team or from a first league to a second league through the use of a transfer portal. The transfer portal may allow a user to select a candidate player and a destination team before the model predicts player-level box score metrics for the player. To generate such predictions, the present system may decompose player performance into a combination of player-level and team-level stylistic features. A model may then be trained to learn how these features interact. Once trained, the model may be deployed to predict player performance on a destination team.

By being able to predict player performance on a destination team and/or destination league, the system may be able to estimate or project the impact of a specific player in terms of their player contribution for a proposed future club. Such metrics may be further used downstream to create a shortlist of players across any number of chosen leagues which may represent the best transfer targets for a particular team or potential replacements for a departing player.

While the present discussion is provided in the context of soccer, those skilled in the art readily understand that such functionality may be extended to other sports.

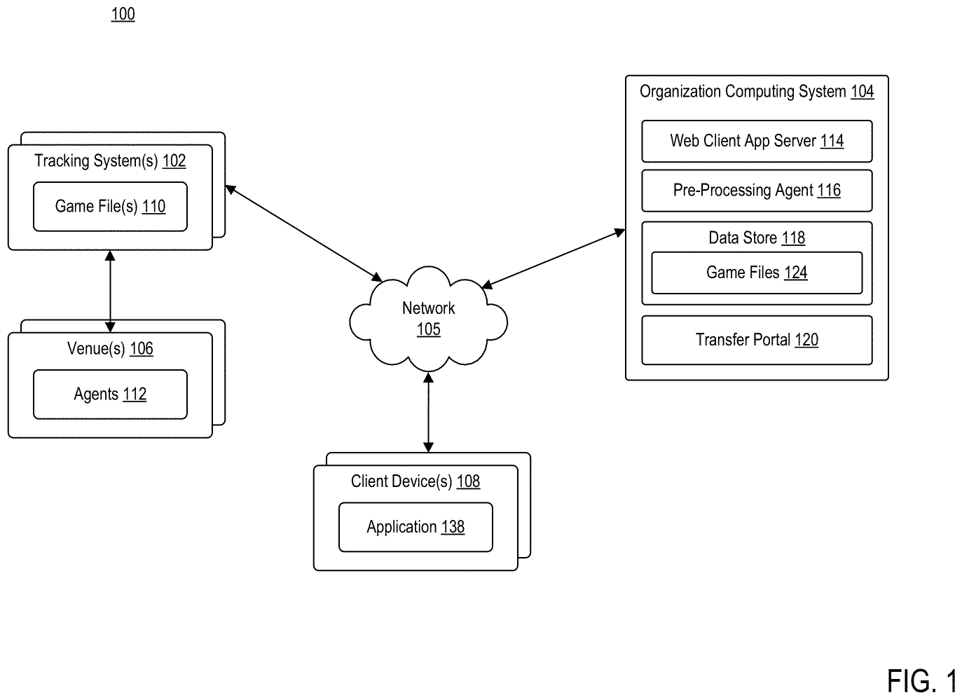

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x, y) position) for all agents and objects on the playing surface for each frame in a game file 110.

Game file 110 may be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing agent 116, a data store 118, and a transfer portal 120. Each of pre-processing agent 116 and transfer portal 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may correspond to each play-by-play event in a particular match. In some embodiments, non-spatial event data may be derived from spatial event data. For example, pre-processing agent 116 may be configured to parse the spatial event data to derive play-by-play information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

In some embodiments, each game file 124 may further include the home and away team box scores. For example, the home and away teams' box scores may include the number of team assists, fouls, rebounds (e.g., offensive, defensive, total), steals, and turnovers at each time, t, during gameplay. In some embodiments, each game file 124 may further include a player box score. For example, the player box score may include the number of player assists, fouls, rebounds, shot attempts, points, free-throw attempts, free-throws made, blocks, turnovers, minutes played, plus/minus metric, game started, and the like. Although the above metrics are discussed with respect to basketball, those skilled in the art readily understand that the specific metrics may change based on sport. For example, in soccer, the home and away teams' box scores may include shot attempts, assists, crosses, shots, and the like.

In some embodiments, each game file 124 may further include Opta event-level data. Exemplary Opta event-level data may include, but is not limited to, expected goals (xG), shot count, expected assists (xA), crosses, final 3rd pass count, total pass count, long/short pass count, penalty area entries, take-on, aggregate defensive actions by 3rds, tackles, clearances, interceptions, 50/50s, ball recovery, headers shots against, expected goals against, expected assists against, passes conceded by 3rds, and the like.

Pre-processing agent 116 may be configured to process data retrieved from data store 118. For example, pre-processing agent 116 may be configured to generate one or more sets of information that may be used to train portions of transfer portal 120.

Transfer portal 120 may be configured to predict a performance of a player when transferred to a new team. For example, a user may be able to select a candidate player and a destination team and, using this information, transfer portal 120 may predict one or more player-level box score metrics of how the player will perform on the destination team. In some embodiments, transfer portal 120 may be trained to predict a plurality of different player-level offensive and defensive outputs and aggregated to per 90 minute metrics (e.g., shots, expected goals (xG), expected assists (xA), take-ons, crosses, penalty area entries, total passes, short passes (e.g., <32m) long passes (e.g., >32m), passes in attacking third, and defensive actions in own, middle, and opposition third).

To build a framework for predicting these player metrics at a new team and/or league, transfer portal 120 may represent player, team, and league entities in a personalized feature space, which may be updated after each game is played. Without accurate representation of players, teams and league that can update over time, it may be difficult to expect reasonable predictive performance from any modelling approach.

Transfer portal 120 may be further configured to handle low data quantity players and teams, such as breakout youth players or newly promoted teams. To handle these challenges, transfer portal 120 may utilize crafted features that may measure both the change in style and ability of the teams and leagues involved in a transfer, in addition to the player's performance relative to other players on their current team. In some embodiments, transfer portal 120 may further utilize a set of adjustment models that predict initial feature values for low data quantity players and teams to be used as prior information, which may be updated as more data is collected for these low data quantity players and teams.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 138. Application 138 may be representative of a web browser that allows access to a website or a stand-alone application. Client device 108 may access application 138 to access one or more functionalities of organization computing system 104. Client device 108 may communicate over network 105 to request a webpage, for example, from web client application server 114 of organization computing system 104. For example, client device 108 may be configured to execute application 138 to propose a trade or acquisition by a destination team of a target player and view the predicted statistics of this target player on the destination team.

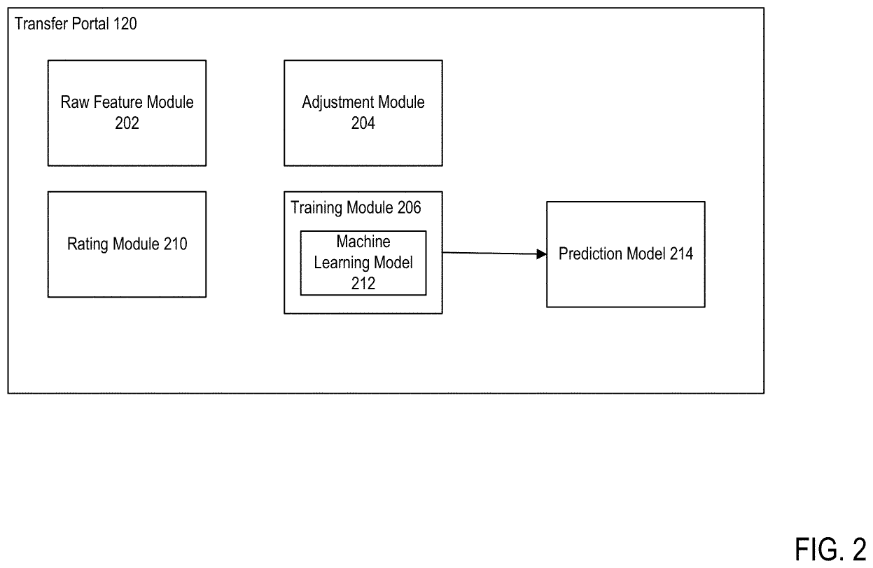

FIG. 2 is a block diagram illustrating transfer portal 120, according to example embodiments. As shown, transfer portal 120 may include a raw feature module 202, an adjustment module 204, and a training module 206. Each of raw feature module 202, adjustment module 204, and training module 206 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Raw feature module 202 may be configured to aggregate one or more features on a per-game level at various levels. For example, raw feature module 202 may be configured to aggregate one or more features at a player level, a team level while a player is in the game (e.g., on the pitch, field, court, ice, etc.), a team level regardless of whether a player is in the game, and a team level by position.

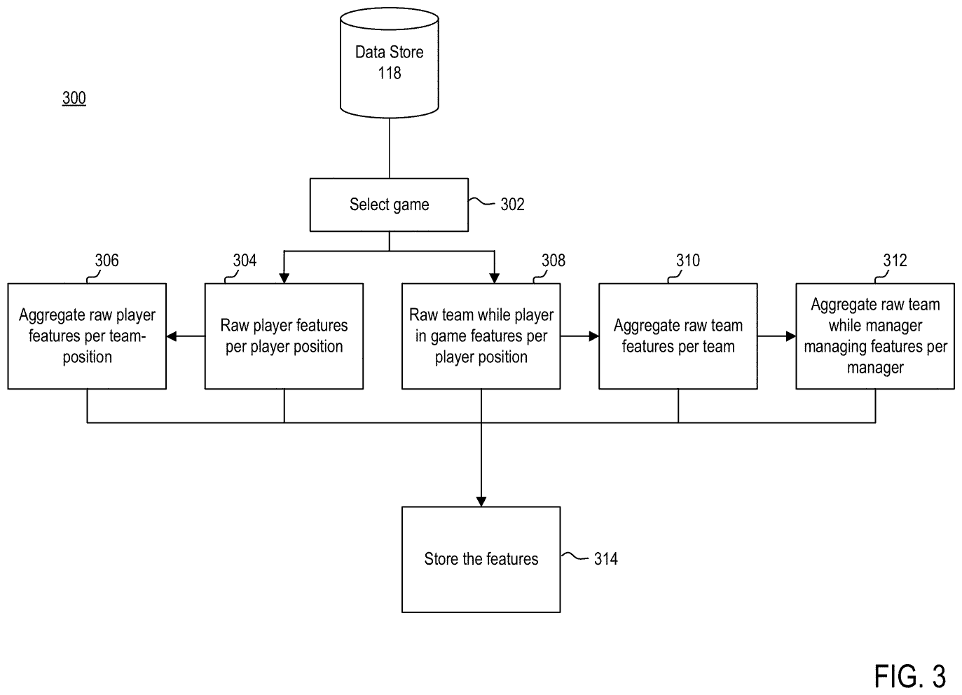

FIG. 3 is a block diagram 300 illustrating raw feature module 202 generating one or more features on a per-game level at various levels, according to example embodiments. As shown, raw feature module 202 obtain event-level data for players and teams from data store 118. In some embodiments, the event-level data may be representative of event-level data provided by Opta. Raw feature module 202 may select a first game file 124 from data store 118 (block 302). Based on first game file 124, raw feature module 202 may first compute raw player features per player-position (block 304). To do so, raw feature module 202 may determine which position or positions a player played during the game (e.g., Full Back, Centre Back, Defensive Midfield, Center, Point Guard, Small Forward, etc.). For example, Player A may have played at Left Wing and Left Back during the game. Raw feature module 202 may determine the position or positions of a player during the game based on the event data. Accordingly, for Player A, raw feature module 202 may count their contributions at each position separately. For example, raw feature module 202 may determine that Jordan Henderson accrued 0.3xG in his 80 minutes of play at Centre Midfield in Game 1.

Raw feature module 202 may generate aggregate player features per team-position (block 306). To do so, raw feature module 202 may aggregate the individual player data for all players of a certain position for each team. For example, raw feature module 202 may aggregate all the event-level data for Liverpool's Centre Midfielders (there are two: Jordan Henderson and Georginio Wijnaldum) to generate raw player features for Centre Midfielders on Liverpool. In some embodiments, raw feature module 202 may compute such features using the player features per player-position computed in block 304. Raw feature module 202 may conduct such process for each position on both teams. In some embodiments, the aggregate generated by raw feature module 202 may be an average (e.g., mean) per 90 minutes across players. For example, if Player A has 0.3xG in 80 minutes at centre midfield (e.g., 0.34xG per 90) and Player B has 0.2xG in 120 minutes at centre midfield (e.g., 0.15xG per 90), this would mean that the aggregate would be, for example:

$$( 0.34 * \frac{80}{200} ) + ( 0.15 * \frac{120}{200} ) = 0.23 x G per 90 average for centre midfield$$

Raw feature module 202 may further compute raw team while player is in the game features per player-position (block 308). To do so, raw feature module 202 may determine event-level data for the team, as a whole, when a particular player is in the game per each position played by the particular feature. For example, raw feature module 202 may determine that Liverpool accrued 1.5 xG while Jordan Henderson was on the pitch and playing Center Midfield in the game. In some embodiments, raw feature module 202 may further take into consideration how the opposing team performed while a player was in the game. In such embodiments, raw feature module 202 may incorporate defensive metrics into the raw team while player is in the game features per player-position.

Raw feature module 202 may further generate aggregate raw team features per team in the game (block 310). For example, raw feature module 202 may determine that, across the entirety of the game, Liverpool accrued 1.8 xG. In some embodiments, raw feature module 202 may generate the aggregate raw team features per team based on the computed raw team while player in the game features per player-position (e.g., block 308).

In some embodiments, raw feature module 202 may further generate an aggregate raw team features while manager managing features per manager (block 312). In other words, raw feature module 202 may take into account how a team performed, depending on who was managing the game. For example, during the course of a season a team may choose to change managers. In another example, a manager may be ejected from a game or suspended. In another example, a manager may have missed a game for personal reasons. As such, raw feature module 202 may generate aggregate raw team data based on the manager or managers in the game. In some embodiments, raw feature module 202 may generate the aggregate raw team features per team based on the computed raw team while player in the game features per player-position (e.g., block 308) and/or aggregate raw team features per team (e.g., block 310).

Raw feature module 202 may then store the generated metrics in data store 118 (block 314).

Referring back to FIG. 2, adjustment module 204 may be configured to use sequential updating to weight observed game-level raw player and team features by team, team-position, and/or league priors for players and/or teams who have not met a minimum threshold of minutes to be observed. Adjustment module 204 may leverage the most up to date representations of both team and player data. In some embodiments, these representations may be updated after each game played by that team or that player.

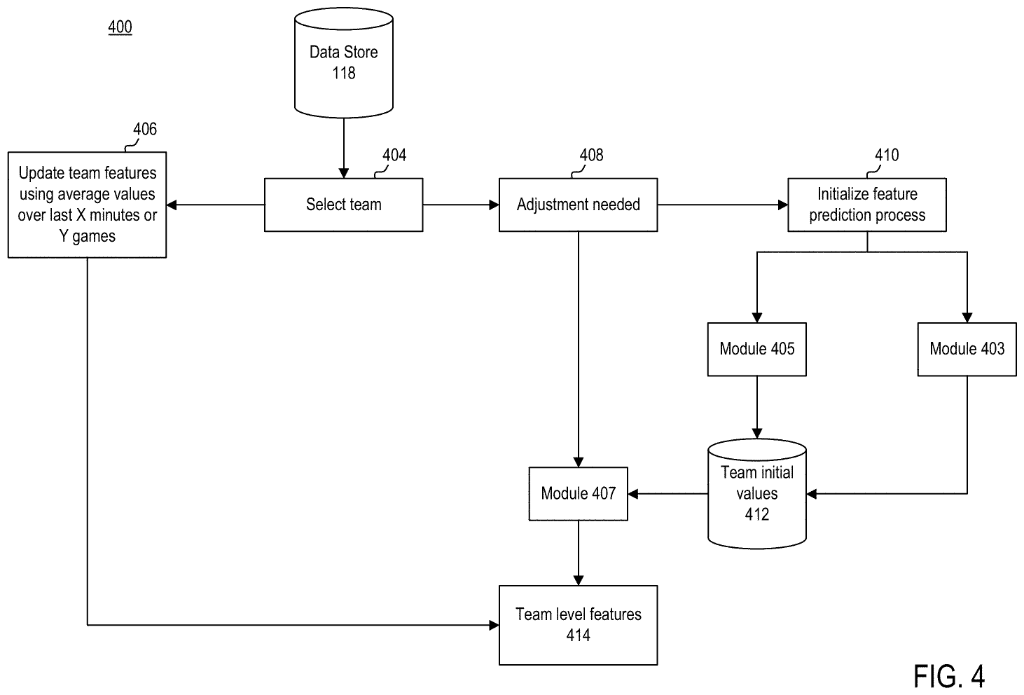

FIG. 4 is a block diagram 400 illustrating adjustment module 204 adjusting game-by-game team-level features, according to example embodiments. As shown, adjustment module 204 may access raw team input data from data store 118. For example, adjustment module 204 may access raw team input data that was generated by raw feature module 202.

At block 404, adjustment module 204 may select a first team. If adjustment module 204 determines that the first team has played a threshold amount of minutes in their current league (e.g., greater than 1000 minutes), then adjustment module 204 may proceed to block 406. At block 406, adjustment module 204 may update team features using average values over the last X minutes (e.g., 1000 minutes) or Y games (e.g., 50 games). In this manner, adjustment module 204 may ensure that the most up-to-date data for the first team is being used.

If, however, adjustment module 204 determines that the first team has not played a threshold amount of minutes in their current league, then adjustment module 204 may determine that the team features require an adjustment (block 408). In some embodiments, adjustment module 204 may adjust the team features based on whether the team has seen or played any minutes in the current league. In other words, if the team is brand new to the current league due to expansion, relegation, or promotion, adjustment module 204 may proceed to block 410.

At block 410, adjustment module 204 may initialize a feature prediction process, in which adjustment module 204 may utilize one or more machine learning techniques to predict team features. If adjustment module 204 determines that there is not at least a threshold amount (e.g., greater than 1000 minutes) of team-level data generally (i.e., in other leagues), then adjustment module 204 may utilize module 403 of adjustment module 204 to initialize team-level metrics for the first team using a baseline prior for the current league. To generate the baseline prior, module 403 may set all feature priors as the average value for the features from teams in the current league the year before. In other words, module 403 may access team-level data of all teams in the current league from the year before and average that data. This averaged data may act as the first team's team-level data.

If adjustment module 204 determines that there is at least a threshold amount (e.g., greater than 1000 minutes) of team-level data generally (e.g., a combination of team-level data from the current league and from other leagues), then adjustment module 204 may utilize module 405 of adjustment module 204 to initialize team-level metrics for the first team. For example, module 405 may utilize a regression model that predicts a change in the first team's features based on a change of relative ability of a team compared to their league (i.e., “ability score”). In other words, if a team gets promoted, module 405 may predict how each feature changes now that the team is expected to be of lower quality compared to the other teams in their league. To generate such prediction, module 405 may leverage both raw team input data and team and league rating input data. Rating data may be representative of a global ranking system developed by STATS Perform. In some embodiments, each team may have a single rating, where the higher the rating, the higher the team's ability. These values may be updated after each game depending on the result (e.g., win/loss/draw) and score (e.g., larger victory margins may increase the gain in rating). In some embodiments, individual team ratings may be aggregated to generate an overall league rating. For example, adjustment module 204 may take the average team rating in a particular league over the past 12 months to generate a league rating.

In some embodiments, the regression model for team adjustments may be defined as:

y_{i,j}=x_{i,j}+αⱼ+βⱼz_{i,j}+ϵ_{i,j}

for targets j=0, . . . n and data points i=0, . . . N, where y_{i,j} may represent the target value for the i^{th} team, j^{th} feature (team per 90 minute value after reaching new league minutes threshold), x_{i,j} may represent the naive expectation offset based on league information for the i^{th} team, j^{th} feature, z_{j,i} may represent the team's relative feature value in previous league for the i^{th} team, j^{th} feature, ϵ_{i,j} may represent the independent and identically distributed error term (e.g., assumed Gaussian) for player i and feature j, and α and β may represent the parameter estimates, which may differ for each target.

In some embodiments, Elo ratings may be one way of generating a team strength rating, the present approach should not be limited to the Elo rating. For example, any type of team rating, such as by human experts, betting markets/predictive markets, and other data-driven team strength ratings may be used in place of or in addition to Elo data. Further, the team strength rating does not need to be a single value, but can instead be a multi-dimensional input, which may capture the various attributes of a team (e.g., offensive, defensive, playing styles (e.g., regular possession, counter-attack, corners, free-kicks, half-court set, fast break, etc.), and the like. Elo ratings may provide a simple approach for updating a team's ability ratings after each game. In some embodiments, the expected result of each match, which may be based on the pre-game Elo difference between two teams, may be compared to the actual result of the match. Based on the difference in expected and actual results, both teams may have their Elo rating adjusted.

Using a specific example, given York City FC in the 6^{th} tier of England (National League North) as of 2021, their final ability score may be represented as a sum of four Elo ratings across their continent, country, league, and within league team values. For example:

E_{York Final Score}=E_{York Within League}+E_{National League North}+E_{England}+E_{Europe}

In some embodiments, the output from module 403 and module 405 may be stored as initial team values (block 412).

Because adjustment module 204 may take a rolling average (i.e., the most recent 1000 minutes), such team level features may change throughout a season. For example, assume the first team does not have a threshold amount of team-level data for the current league (e.g., 500 minutes). To account for this, adjustment module 204 may utilize module 407. Module 407 may be configured to update team-level features using a weighted average of observed team metrics and the initial team values which have been calculated using module 405 or module 403. As the team continues to play, after a given number of games, the first team may have reached the 1000-minute threshold in the current league. As a result, adjustment module 204 no longer needs to leverage module 407 and can instead proceed to 406.

The output from such process may be a set of up-to-date team-level features 414 (e.g., team-level features based on the last 1000 minutes of play) per game. In some embodiments, team-level features 414 may be stored on a team basis and a team-position basis.

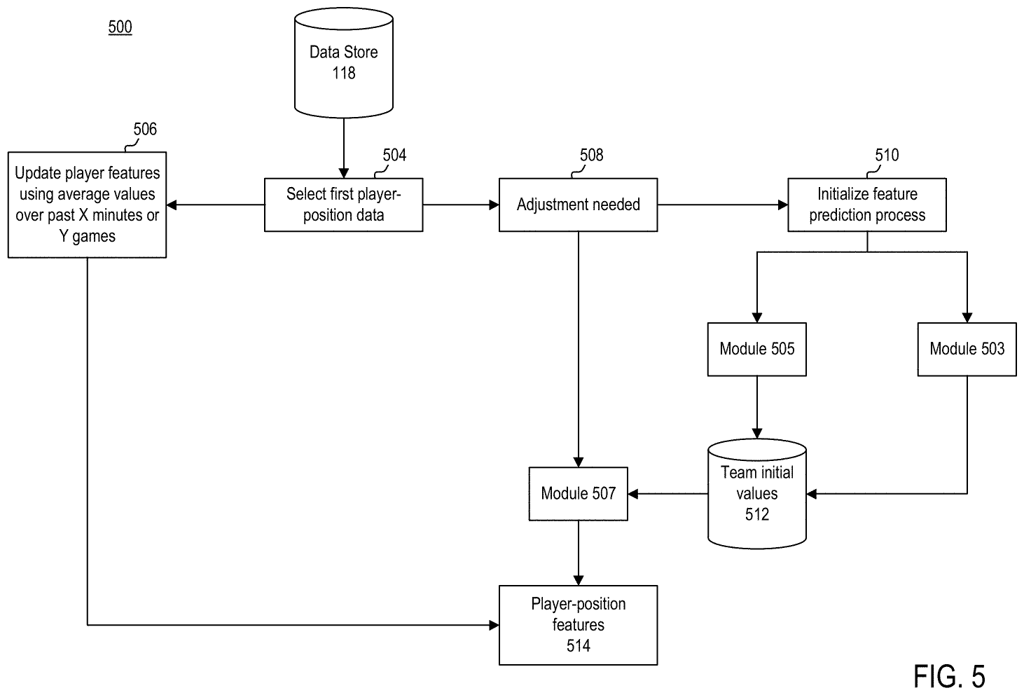

FIG. 5 is a block diagram 500 illustrating adjustment module 204 adjusting game-by-game player-level features, according to example embodiments. As shown, adjustment module 204 may access raw player input data from data store 118. For example, adjustment module 204 may access raw player input data that was generated by raw feature module 202.

At block 504, adjustment module 204 may select a unique first player-position-team-league combination. In other words, adjustment module 204 may identify a first player in a first position on a first team in a first league. Using a specific example, adjustment module 204 may select Jordan Henderson, as a centre midfielder, playing on Liverpool, in the English Premier League. If adjustment module 204 determines that the player has played a threshold amount of minutes at a first position for a first team in a first league, then adjustment module 204 may proceed to block 506. At block 506, adjustment module 204 may update player features using average values over the last X minutes (e.g., 1000 minutes) or Y games (e.g., 50 games). In this manner, adjustment module 204 may ensure that the most up-to-date data for the first player is being used.

If, however, adjustment module 204 determines that the first player has not played a threshold amount of minutes at the first position for the first team in the first league, then adjustment module 204 may determine that the player features require an adjustment (block 508). In some embodiments, adjustment module 204 may adjust the player features based on whether the player has seen or played any minutes at the first position on the first team and in the current league. In other words, if the player is brand new to the current league due to expansion, relegation, or promotion, adjustment module 204 may proceed to block 510.

At block 510, adjustment module 204 may initialize a feature prediction process, in which adjustment module 204 may utilize one or more machine learning techniques to predict player features. If adjustment module 204 determines that there is not at least a threshold amount (e.g., greater than 1000 minutes) of player-position data generally (i.e., in other leagues), then adjustment module 204 may utilize module 503 of adjustment module 204 to initialize player-level metrics for the first player using a baseline prior for the current team at the current position. To generate the baseline prior, module 503 may set all feature priors as the average value for players in their team who play the same position. For example, a new striker at Manchester United may be given the average features of Manchester United strikers if there is not a threshold amount of player-data for that new striker.

If adjustment module 204 determines that there is at least a threshold amount (e.g., greater than 1000 minutes) of player-position data generally (e.g., a combination of player-level data from the current league and from other leagues), then adjustment module 204 may utilize module 505 of adjustment module 204 to initialize player-level metrics for the first player-position. In some embodiments, module 505 may utilize a regression model that may be trained to predict player performance. For example, module 505 may use a regression model that may predict player performance based on one or more of the player's feature value at their previous team or league, the average feature value for players in their position at the new or destination team, the difference in average feature value for players in their position between their old team and new team (e.g., new club strikers' shots per 90 minutes—old club strikers' shots per 90 minutes), and/or the change in relative rating between the new team and the told team (e.g., difference between team and league rating scores).

In some embodiments, the regression model for player adjustments may be defined as:

y_{i,j,k}=αⱼ+β_{1,j}x_{1,i,j,k}+β_{2,j}x_{2,i,j,k}+β_{3,j}x_{3,i,j,k}+β_{4,j} x_{4,i,j}+β_{5,j} x_{4,i,j}²+β_{6,j} x_{4,i,j}³+ϵ_{i,j}

for targets j=0, . . . n, players i=0, . . . N, and positions k=0, K, . . . where y_{i,j,k} may represent the target value for the i^{th} player, j^{th} feature in the k^{th} position (player per 90 minute values after reaching minutes threshold), X_{1,i,j,k} may represent the previous per 90 minute feature value for the i^{th} player, j^{th} feature in the k^{th} position, x_{2,i,j,k} may represent the average feature value for players in their position in the new team for the i^{th} player, j^{th} feature in the k^{th} position, X_{3,i,j,k} may represent the difference in average feature value for players in their position between their old and new team for i^{th} player, j^{th} feature in the kth position, x_{4,i,j} may represent the change in relative ability between the teams for the i^{th} player, j^{th} feature, and ϵ_{i,j} may represent the independent and identically distributed error term (assumed Gaussian) for player i, feature j, and position k.

In some embodiments, the outputs from module 503 and module 505 may be stored as initial player values (block 512).

Because adjustment module 204 take a rolling average (i.e., the most recent 1000 minutes), such player level features may change throughout a season. For example, assume the first player does not have a threshold amount of player-position data for the current team-league (e.g., 500 minutes). To account for this, adjustment module 204 may utilize module 507. Module 507 may be configured to update player-position features using a weighted average of observed player metrics and the initial player values which have been calculated using module 505 or module 503. As the player continues to play, after a given number of games, the player-position may have reached the 1000 minute threshold in the current team-league. As a result, adjustment module 204 may no longer need to leverage module 507 and can instead proceed to 506.

Mathematically, denoting feature i for player-position-team-league j at game g as X_{i,j,g}this may be defined as:

X_{i,j,g}=(1−W_{j,g})P_{i,j}+W_{j,g} R_{i,j,g}

where weighting

$${w}_{j , g} = min ( 1 , {\sum }_{t = 0}^{g} \frac{{m}_{j , t}}{c} )$$

may be the minimum of 1 and the sum of minutes played m by the player-position-team-league j in all their games up to game g, divided by some user defined constant c. Finally, P_{i,j} may be the prior value for player-position-team-league j in feature i, and R_{i,j,g} may be the raw rolling window average of feature i for player-position-league-season j at game g. By controlling the constant c, the speed at which the weighting shits form the prior to the rolling average may be adjusted.

The output from such process may be a set of up-to-date player-position features 514 (e.g., team-level features based on the last 1000 minutes of play) per game.

Referring back to FIG. 2, in some embodiments, transfer portal 120 may further include a rating module 210. Rating module 210 may create rating features based on, for example, Elo statistics. Broadly, Elo statistics may refer to a rating of a team based on head-to-head performance, which rating module 210 can average over leagues to obtain a league Elo rating.

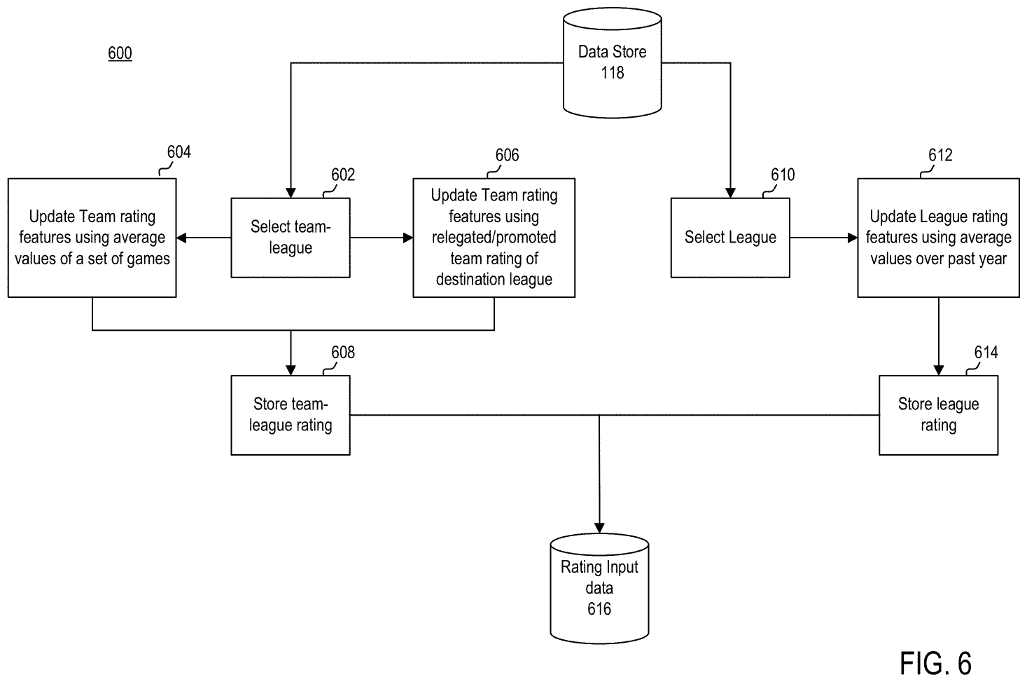

FIG. 6 is a block diagram 600 illustrating rating module 210 configured to create rating features, according to example embodiments. As shown, rating module 210 may access game-by-game ratings data. In some embodiments, such as that shown in FIG. 6, the game-by-game rating data may be stored in data store 118. In some embodiments, the game-by-game rating data may be stored in a separate data store or database. Rating module 210 may retrieve two types of rating data: team rating data and league rating data.

With respect to team rating data, at block 602, rating module 210 may select a first time in a first league. If rating module 210 determines that the team has played greater than zero games in the current league in the past year, then at block 604, rating module 210 may update rating features for the first team using average values over the past games up to a maximum set number of games (e.g., 90 games) or minutes (e.g., 1000 minutes). If rating module 210 determines that the team has not played any games in the current league in the past year (e.g., before first game of season after promotion/relegation/expansion), then at block 606, rating module 210 may update team rating features using relegated or promoted team ratings of the league the team is moving to. At block 608, rating module 210 may then store the team-league rating features (generated at block 604 and/or block 606).

With respect to league rating data, at block 610, rating module 210 may select a first league. For example, rating module 210 may select the first league corresponding to the first team. At block 612, rating module 210 may update league rating features using average values over the past year. For example, rating module 210 may update league rating features using average team rating features from the past year. At block 614, rating module 210 may then store the league rating features (generated at block 612).

Both league rating features (block 614) and team-league rating features (block 608) may be stored as rating input data 616.

Referring back to FIG. 2, training module 206 may be configured to train machine learning model 212 to generate a player prediction for a new team. In some embodiments, machine learning model 212 may be representative of a neural network model for generating prediction. Training module 206 may train machine learning model 212 to use game-level adjusted features to predict player performance based on the target team. Once trained, training module 206 may output a fully trained prediction model 214 for deployment. Trained prediction model 214 may be configured to receive a query, such as a proposed trade or acquisition of a player to destination team, and generate a prediction regarding how that player will perform on the destination team. In some embodiments, the prediction may take the form of a per game rate (e.g., per 90 minutes, per 36 minutes, etc.) of how the player will perform. To generate such prediction, prediction model 214 may be configured to receive team-level adjusted features, player-level adjusted features, and rating input data to predict the performance of a player when transferred to any chosen team. For example, prediction model 214 may compare team features of the chosen player to the new team features.

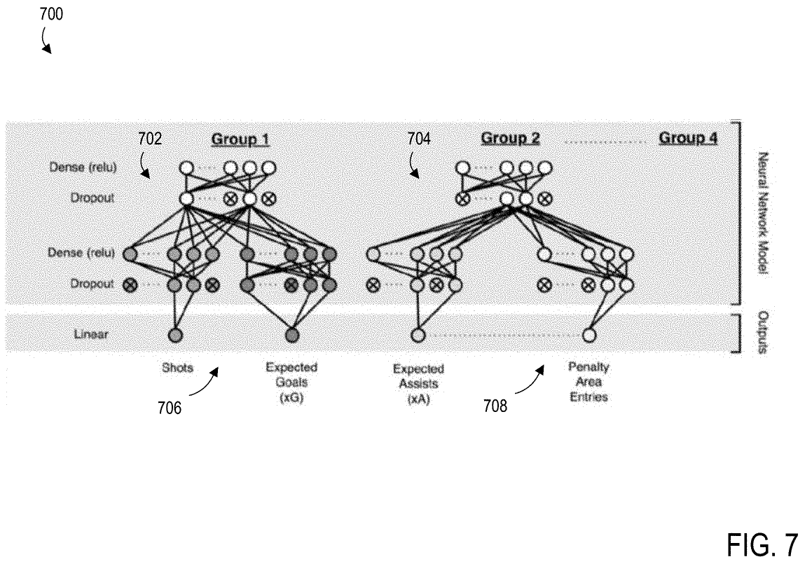

FIG. 7 is a block diagram illustrating a model architecture 700 of prediction model 214, according to example embodiments. As discussed herein, prediction model 214 may be trained to take various input features and translate those input features into a plurality of predictions over a plurality of target metrics. In some embodiments, for modeling, a grouped feature structure where related targets (e.g., xG and shots per 90) may be modelled together using a multi-head approach. Such approach may allow prediction model 214 to use unique subsets of input features that may be relevant to the targets in each group, to share information across the prediction targets, without overloading prediction model 214 with less relevant data that may introduce noise and negatively impact predictive model performance.

Exemplary grouped features may include, but are not limited to:

| Group number | Targets |
|---|---|
| 1 (Shooting) | Shots, Expected Goals (xG) |
| 2 (Passing) | Expected Assists (xA), Crosses, Total Passes, Total |
| | Short Passes (<32 m), Total Long Passe (≥32 m), |
| | Passesin Attacking Thirds, Penalty Area Entries |
| 3 (Dribbling) | Take-ons |
| 4 (Defending) | Defensive Actions in Own Third, Defensive Actions in |
| | Middle Third, Defensive Actions in Opposition Thirds |

Using a specific example, across a plurality of targets (e.g., 13 targets), four separate models may be fit to the data based on various groupings. In some embodiments, a multi-head neural network model may be fit to each target group using Tensorflow. In each case, a dense initial layer of all features for the target group may be used, before splitting into individual layers for each target. Such structure may allow for the sharing of relevant predicting information using the initial dense layer before splitting out into uniquely optimized layers for each target. During training of prediction model 214, several hyperparameters may be optimized over a large search space using a Bayesian hyperparameter optimization library. Exemplary hyperparameters may include learning rate, batch size, dropout, and number of neurons in each hidden layer.

For example, as shown in FIG. 7, model architecture 700 may include a first neural network model 702 corresponding to group 1 and a second neural network model 704 corresponding to group 2. For ease of illustration, only first neural network model 702 and second neural network model 704 are shown. Those skilled in the art understand, however, that there may be a dedicated neural network model for each group, such as group 3 and 4.

First neural network model 702 may be configured to generate output 706. As shown, exemplary outputs may include shots and expected goals. Similarly, second neural network model 704 may be configured to generate output 708. As shown, exemplary outputs may include expected assists and penalty area entries.

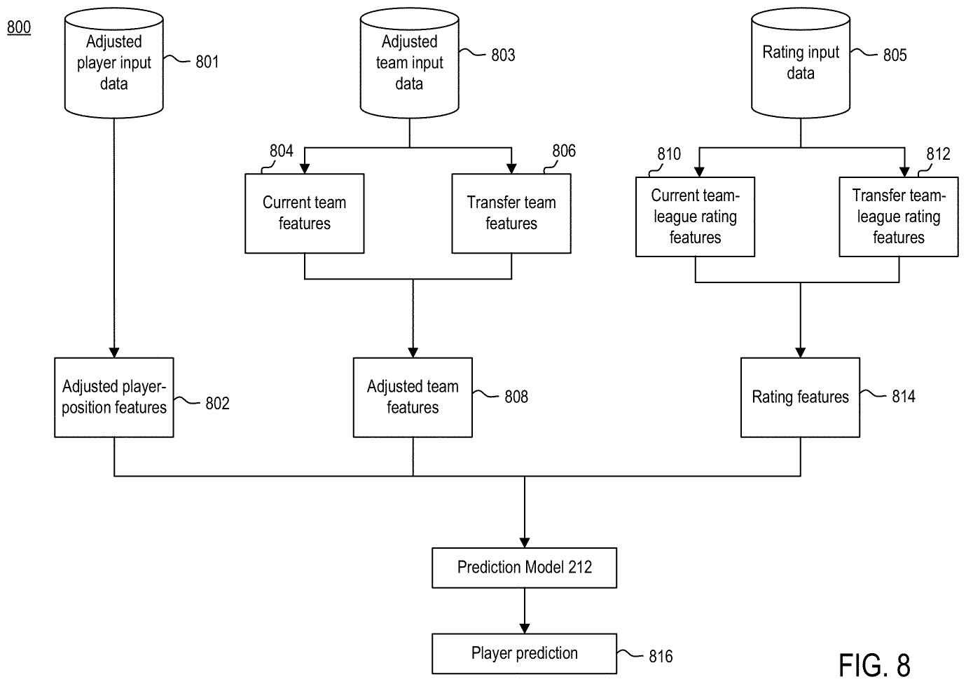

FIG. 8 is a block diagram 800 illustrating a method for generating player-level box score predictions using adjusted player and team features, as well as rating features, according to exemplary embodiments. As shown, pre-processing agent 116 may access adjusted player input data 801 (as generated in FIG. 5), adjusted team input data 803 (as generated in FIG. 4), and rating input data 805 (as generated in FIG. 6). At block 802, pre-processing agent 116 may access adjusted player-position features of the target player from adjusted player input data.

At block 804, pre-processing agent 116 may access current team features of the target player from the adjusted team input data. At block 806, pre-processing agent 116 may access destination team features of the destination team from adjusted input data. At block 808, pre-processing agent 116 may aggregate the destination team features with the current team features to generate adjusted team features.

At block 810, pre-processing agent 116 may access current team-league rating features. For example, pre-processing agent 116 may retrieve current team-league rating features corresponding to the current team and current league of the current team. At block 812, pre-processing agent 116 may access transfer team-league rating features. For example, pre-processing agent 116 may retrieve destination team-league rating features corresponding to the destination team and destination league of the current team. In some embodiments, the destination league is different from the current league. In some embodiments, the destination league is the same as the current league. At block 814, pre-processing agent 116 may aggregate the current team-league rating features with the destination team-league rating features to generate rating features.

Prediction model 214 may be configured to generate player boxes core predictions 816 based on the adjusted player-position features, adjusted team features, and rating features. Prediction model 214 may take these features and identify key markers to generative one or more predictive targets. For example, one may expect that the passes per 90 minutes for Jordan Henderson playing Central Midfield at a new team would be highly correlated with his passes per 90 minutes in Central Midfield at his current club and the average passes per 90 minutes for Central Midfielders at his new club. However, other information, such as crosses per 90 minutes for Central Midfielders at the new team, or opposition passes allowed per 90 minutes at the new team might also provide some vital information for the analysis. During training, machine learning model 212 may learn how these pieces of information may interact with each other and help improve the understanding of how Jordan Henderson's profile would fit within a new team, where the complex interactivity between all of these pieces of information makes it difficult to extract this knowledge using simple aggregation or regression models.

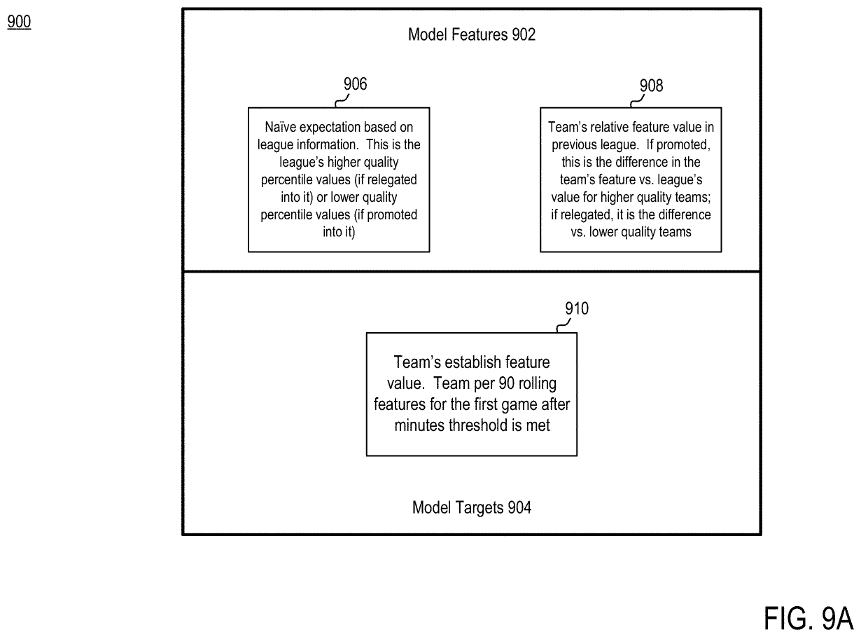

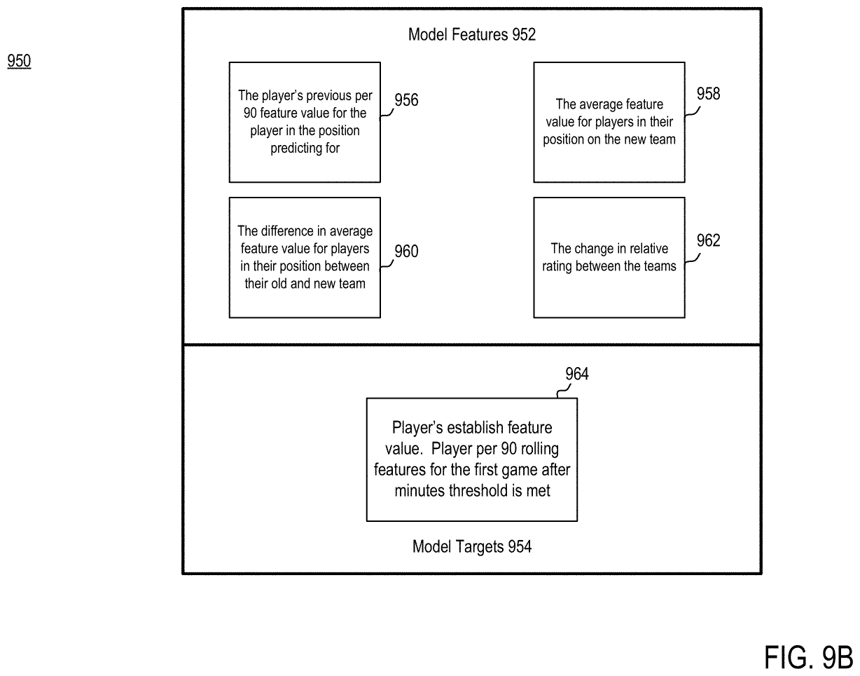

FIG. 9A is a block diagram illustrating a training data structure 900 for adjustment module 204, according to example embodiments. In some embodiments, training data structure 900 may correspond to one or more modules of adjustment module 204 that may be associated with team adjustment features, such as those discussed above in conjunction with FIG. 4.

As shown, training data structure 900 may include model features 902 and model targets 904. As previously mentioned, if adjustment module 204 has seen a destination team in the previous season (e.g., the team is promoted into a new league), adjustment module 204 may execute a team adjustment model (e.g., module 405) to set priors. For example, module 405 may be a regression model configured to predict a team's features based on a change of relative ability of a team compared to their league and the typical values for this feature in the league they are moving to. In other words, if a team gets promoted, module 405 may predict how each feature changes now that the team is expected to be of lower quality compared to the other teams in their league and that the league might have different styles of play.

In some embodiments, adjustment module 204 may be configured to adjust each team feature for the first game of a new league, based on any changes of both team and league ratings between the team's final game of their previous season and the first game on their new season. For example, if there is a high expected goals team that gets promoted, it might be expected that their extra goals per 90 minutes in their first season in the new league will be much lower than in their promotion season. Therefore, team adjustment module may adjust the initial extra goals per 90 minutes value in their new league to one which is more reasonable given their new team and league ratings.

To improve the initial team values, the system may train a team adjustment model which predicts the feature value of the new season based on two pieces of information. Model features 902 may include a naive expectation (block 906) based on league information, which is the baseline value for a team entering the league for that feature. If a team is moving up into this league, this is a value from the lower quality teams in that league, whilst if they are moving down into the league this is a value from the higher quality teams in the league. Model features 902 may further include the team's relative feature value in the previous league (block 908). This may be the difference between the team's feature value in the previous league compared to other top teams if they were promoted, or other lower teams if they were relegated. Model targets 904 may include team, per game, rolling features for the first game after a threshold number of games or minutes is met in their new league (block 910). Using these model targets, training module 206 may train a simple regression model to predict the team rolling features when they move league.

In some embodiments, the aim of this model is to provide an initial value which is then totally ignored after a specific game or minute threshold is met. As such, the system may consider the target to be predicting a team's box score rolling features (e.g., per 90 minute rolling features) in the new league once this threshold is met. For example, assume that the threshold is 2000 minutes before the team features ignore their prior values. Team adjustment model (e.g., module 405) may be used by adjustment module 204 to provide a reasonable approximation regarding how a team's features will change between the end of the previous season and 2000 minutes into their new league season.

To do this, the targets may be defined as a team's box score rolling values (e.g., per 90 minute rolling values) from the first game of the current season once the minutes threshold is met. Currently, as reflected above, two features may be used: the naive expectation based on league information feature is used as an offset, whilst the team's relative feature value in previous league is used as a standard feature.

FIG. 9B is a block diagram illustrating a training data structure 950 for adjustment module 204, according to example embodiments. In some embodiments, training data structure 950 may correspond to one or more modules of adjustment module 204 that may be associated with team adjustment features, such as those discussed above in conjunction with FIG. 5.

As shown, training data structure 950 may include model features 952 and model targets 954. As previously mentioned, if adjustment module 204 has seen a destination player-position in the previous season, adjustment module 204 may execute a player adjustment model (e.g., module 505) to set priors. In some embodiments, the aim of player adjustment model (e.g., module 505) may be to adjust each player feature for the first game of a new league, new team, and/or new position based on previously known information about the player, the team and the league. For example, if a player is playing at Centre Back and their team is promoted, what is considered a decent or suitable prior value for their features in the new league? In another example, if a Centre Back joins a new team, the system may need a prior value for their features. In all cases, as shown in FIG. 9B, the prior/initial features may be weighted with their true box score features (e.g., per 90 minute features) over time, where this weight may eventually move completely to the true box score features (e.g., true per 90 minute features) and away from the prior/initial values.

Model features may include the player's feature values at their current team (block 956), the average feature value for players in their position at their new team (block 958), the difference in average feature values for players in their position between the new and old team (block 960), and the change of relative ability of their team compared to their league (e.g., rating data) (block 962). In other words, if a player moves to a team which passes more, module 505 may predict how each feature changes now that the player is expected to pass more often as part of the new team's style. In some embodiments, block 960 may provide how the teams that the player is moving between play. If, for example, a player is moving leagues but remains on the same team (e.g., promotion or relegation), then the comparison would be between the team's features in the previous league against the new league projections. In some embodiments, block 962 may capture whether the player is moving from a team doing well in their division to one that is doing badly, or vice versa. If the player is moving leagues but remains on the same team, the system may compare how that team's relative rating changes between leagues.

Model targets 904 may include player, per game, rolling features for the first game after a threshold number of games or minutes is met in their new position-team-league (block 964). Using these model targets, training module 206 may train a simple regression model to predict the player-position rolling features when they move league or team.

In some embodiments, the aim of player adjustment model (e.g., module 505) may be to provide an initial value which may be ignored after a specific game or minute threshold is met. As such, the target may be to predict player box score prediction (e.g., per 90 minute predictions) rolling features in the new team, new league, and/or new position once this threshold is met. For example, assume that the threshold is 990 minutes before the player features ignore their prior values. A player adjustment model should be used to provide a reasonable approximation to how a player's features will change between the start of their new position, new league, and/or new team and 990 minutes into their new role. To do this, the targets may be defined as player box score prediction rolling values (e.g., per 90 minute rolling values) from the first game of the current team, current league, and/or current position once the minutes threshold is met.

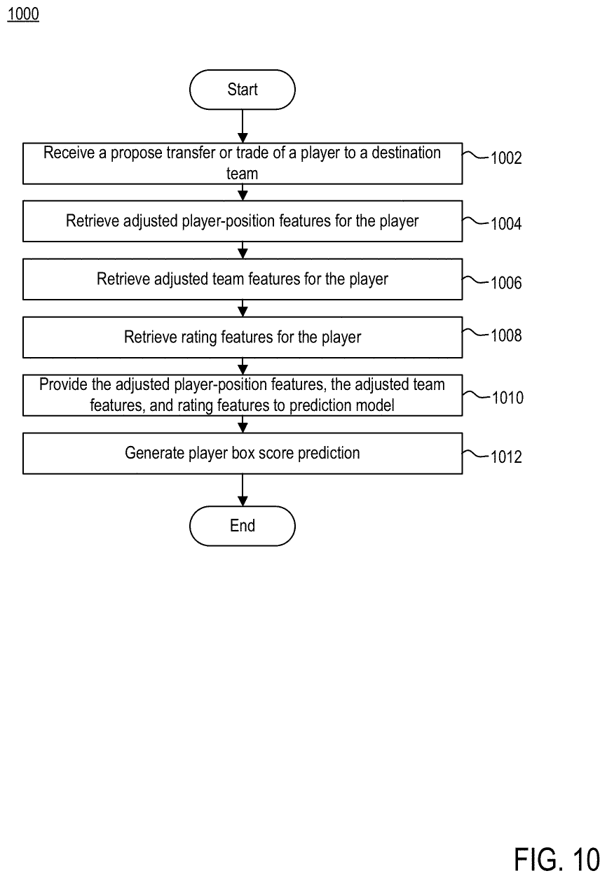

FIG. 10 is a flow diagram illustrating a method 1000 of generating a player transfer prediction, according to example embodiments. Method 1000 may begin at step 1002.

At step 1002, organization computing system 104 may receive a request to generate a prediction for transferring a first player to a destination team. The request may indicate one or more of the name or ID of the first player, a name or ID of the current team of the first player, and/or the name or ID of the destination team for the first player.

At step 1004, organization computing system 104 may retrieve adjusted player-position features for the first player. For example, pre-processing agent 116 may access adjusted player-position features of the target player from adjusted player input data. Adjusted player-position features of the target player may be generated based on raw player features per player position data. For example, adjusted player-position features may capture the most recent X minutes or Y games a player has played at a certain position for a team in a league.

At step 1006, organization computing system 104 may retrieve adjusted team features for the first player. For example, pre-processing agent 116 may access current team features of the target player from adjusted team and team-position input data and access destination team features of the destination team from adjusted input data. This information may be aggregated or combined for future input to prediction model 214.

At step 1008, organization computing system 104 may retrieve rating features for the player. For example, pre-processing agent 116 may access current team-league rating features and destination team-league rating features. In some embodiments, the destination league is different from the current league. In some embodiments, the destination league is the same as the current league. This information may be aggregated or combined for future input to prediction model 214.

At step 1010, organization computing system 104 may input the adjusted player-position features, the adjusted team features, and the rating features to prediction model 214. Prediction model 214 may analyze the adjusted player-position features, the adjusted team features, and the rating features to generate a prediction directed to how a player will perform on the destination team.

At step 1012, organization computing system 104 may generate a player box score prediction. In some embodiments, the player box score prediction may be a per game box score prediction that captures how a player will perform on the destination team. Exemplary metrics may include, but are not limited to, expected goals (xG), shot count, expected assists (xA), crosses, final 3rd pass count, total pass count, long/short pass count, penalty area entries, take-on, aggregate defensive actions by 3rds, tackles, clearances, interceptions, 50/50s, ball recovery, headers shots against, expected goals against, expected assists against, passes conceded by 3rds, and the like.

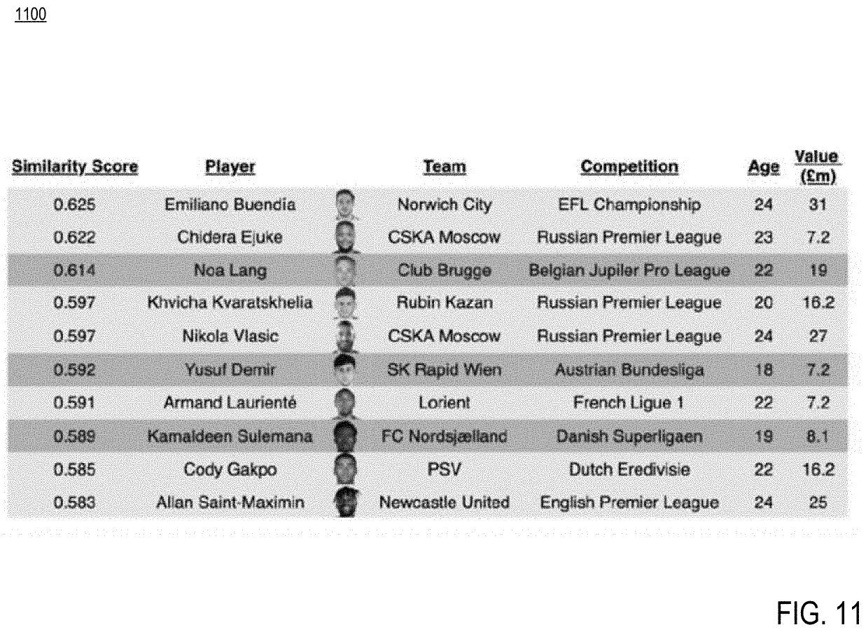

FIG. 11 illustrates an example shortlist 1100 generated by transfer portal 120, according to example embodiments. Shortlist 1100 may represent a shortlist of ten wingers that are most suitable to receive in a trade for Stade Rennais FC. The score may be a weighted average of several per 90 minute metrics using custom sliders.

In some embodiments, transfer portal 120 may be configured to simulate the performance of a transferred player across a plurality of metrics (e.g., 13 metrics). Although transfer portal 120 could simply generate an ordered list of players by a single predicted metric (e.g., highest xG per 90), an end user may wish to evaluate prospective transfers more holistically across a range of metrics. Accordingly, transfer portal 120 may create an overall score based on a set of custom weightings, which may allow the user to quantify the importance of each metric. For example, for an attack-minded winger, an end user may be more interest in goals and assists than defensive actions.

In some embodiments, each predicted target may be normalized and multiplied by a user-defined weighting between 0 and 1, with a final score between 0 and 1 derived by summing weighted scores and divide the sum of the weights. Exemplary weightings may include:

| Target | Weighting |
|---|---|
| Take-ons | 1.0 |
| Expected Assists (xA) | 1.0 |
| Expected Goals (xG) | 0.7 |
| Crosses | 0.2 |
| Penalty Area Entry Passes | 0.2 |

The customized weightings may be used to generate shortlist 1100 ordered by a similarity score, roughly based on the performance profile of a target player (e.g., Jeremy Doku at Stade Rannais FC).

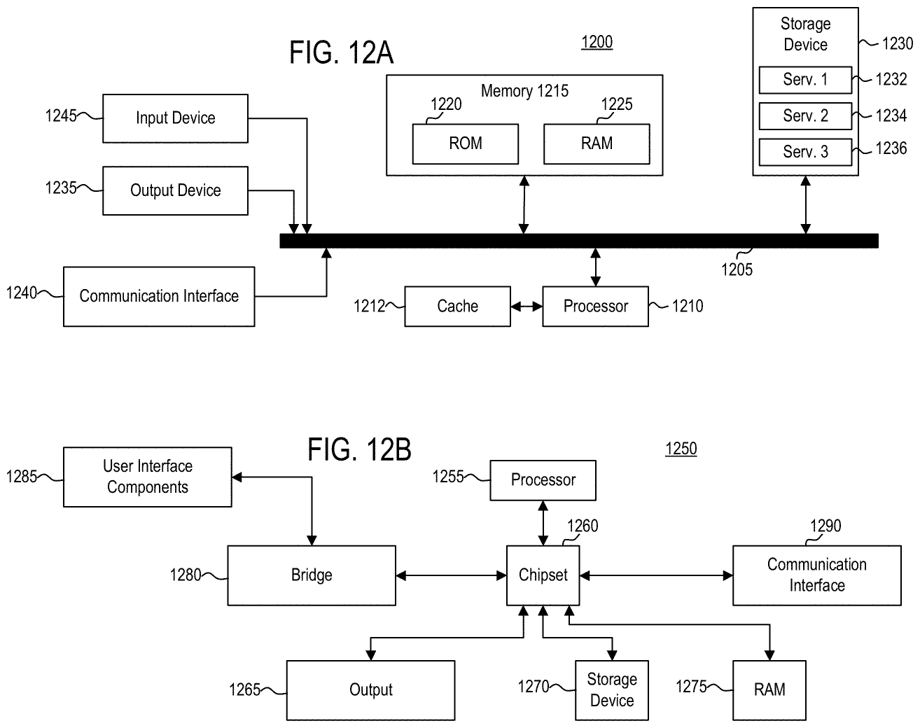

FIG. 12A illustrates a system bus architecture of computing system 1200, according to example embodiments. System 1200 may be representative of at least a portion of organization computing system 104. One or more components of system 1200 may be in electrical communication with each other using a bus 1205. System 1200 may include a processing unit (CPU or processor) 1210 and a system bus 1205 that couples various system components including the system memory 1215, such as read only memory (ROM) 1220 and random access memory (RAM) 1225, to processor 1210. System 1200 may include a cache of high-speed memory connected directly with, in close proximity to, or integrated as part of processor 1210. System 1200 may copy data from memory 1215 and/or storage device 1230 to cache 1212 for quick access by processor 1210. In this way, cache 1212 may provide a performance boost that avoids processor 1210 delays while waiting for data. These and other modules may control or be configured to control processor 1210 to perform various actions. Other system memory 1215 may be available for use as well. Memory 1215 may include multiple different types of memory with different performance characteristics. Processor 1210 may include any general purpose processor and a hardware module or software module, such as service 1 1232, service 2 1234, and service 3 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction with the computing system 1200, an input device 1245 may represent any number of input mechanisms, such as a microphone for speech, a touch-sensitive screen for gesture or graphical input, keyboard, mouse, motion input, speech and so forth. An output device 1235 may also be one or more of a number of output mechanisms known to those of skill in the art. In some instances, multimodal systems may enable a user to provide multiple types of input to communicate with computing system 1200. Communications interface 1240 may generally govern and manage the user input and system output. There is no restriction on operating on any particular hardware arrangement and therefore the basic features here may easily be substituted for improved hardware or firmware arrangements as they are developed.

Storage device 1230 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 1225, read only memory (ROM) 1220, and hybrids thereof.

Storage device 1230 may include services 1232, 1234, and 1236 for controlling the processor 1210. Other hardware or software modules are contemplated. Storage device 1230 may be connected to system bus 1205. In one aspect, a hardware module that performs a particular function may include the software component stored in a computer-readable medium in connection with the necessary hardware components, such as processor 1210, bus 1205, output device 1235 (e.g., display), and so forth, to carry out the function.

FIG. 12B illustrates a computer system 1250 having a chipset architecture that may represent at least a portion of organization computing system 104. Computer system 1250 may be an example of computer hardware, software, and firmware that may be used to implement the disclosed technology. System 1250 may include a processor 1255, representative of any number of physically and/or logically distinct resources capable of executing software, firmware, and hardware configured to perform identified computations. Processor 1255 may communicate with a chipset 1260 that may control input to and output from processor 1255. In this example, chipset 1260 outputs information to output 1265, such as a display, and may read and write information to storage device 1270, which may include magnetic media, and solid state media, for example. Chipset 1260 may also read data from and write data to storage device 1275 (e.g., RAM). A bridge 1280 for interfacing with a variety of user interface components 1285 may be provided for interfacing with chipset 1260. Such user interface components 1285 may include a keyboard, a microphone, touch detection and processing circuitry, a pointing device, such as a mouse, and so on. In general, inputs to system 1250 may come from any of a variety of sources, machine generated and/or human generated.

Chipset 1260 may also interface with one or more communication interfaces 1290 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 1255 analyzing data stored in storage device 1270 or storage device 1275. Further, the machine may receive inputs from a user through user interface components 1285 and execute appropriate functions, such as browsing functions by interpreting these inputs using processor 1255.

It may be appreciated that example systems 1200 and 1250 may have more than one processor 1210 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

1 A method, comprising:
receiving, by a computing system, a request to project a performance of a first player from a current team on a destination team;
based on the request, generating, by the computing system, player-position features corresponding to the first player, wherein the player-position features comprise a rolling average of historical player performance data of the first player while playing a first position;
generating, by the computing system, team features corresponding to the first player, wherein the team features comprise a first rolling average of historical team performance data of the current team and a second rolling average of historical team performance data of the destination team;
generating, by the computing system, rating features for the first player, wherein the rating features comprise a first rolling average of team-league rating features for the current team and a current league corresponding to the current team and second rolling average of team-league rating features for the destination team and a destination league corresponding to the destination team; and
generating, by the computing system via a prediction model, a player box score prediction based on the player-position features, the team features, and the rating features, wherein the player box score prediction comprises a plurality of per game metrics of the first player on the destination team.

2. The method of claim 1, further comprising:
training, by the computing system, the prediction model to generate the player box score prediction by:
generating a training data set, the training data set comprising historical player features and historical team features for a plurality of players and a plurality of teams across a plurality of seasons, and
learning, by the prediction model, relationships between the historical player features and the historical team features.

3. The method of claim 2, further comprising:
comparing, by the computing system, a predicted set of box score data for each player of the plurality of players to actual box score data; and
based on the comparing, adjusting, by the computing system, one or more parameters of the prediction model.

4. The method of claim 1, wherein generating, by the computing system, the team features corresponding to the first player comprises:
accessing raw team data for the destination team;
determining that the destination team has not played at least a threshold amount of minutes in the destination league; and
based on the determining, adjusting the raw team data based on an average performance of teams in the destination league.

5. The method of claim 1, wherein generating, by the computing system, the player-position features corresponding to the first player comprises:
accessing raw player data for the first player in the destination league;
determining that the first player has not played at least a threshold amount of minutes in the destination league; and
based on the determining, adjusting the raw player data based other player data on the destination team that play a same position as the first player.

6. The method of claim 1, further comprising:
determining, by the computing system, that the first player has played a new game; and
based on the determining, updating, by the computing system, the player-position features, the team features, and the rating features based on metrics associated with the new game.

7 The method of claim 1, wherein the rating features are team and player rating features.

8. A non-transitory computer readable medium having a sequence of instructions, which, when executed by a processor, causes a computing system to perform operations comprising:
receiving, by the computing system, a request to project a performance of a first player from a current team on a destination team;
based on the request, generating, by the computing system, player-position features corresponding to the first player, wherein the player-position features comprise a rolling average of historical player performance data of the first player while playing a first position;
generating, by the computing system, team features corresponding to the first player, wherein the team features comprise a first rolling average of historical team performance data of the current team and a second rolling average of historical team performance data of the destination team;
generating, by the computing system, rating features for the first player, wherein the rating features comprise a first rolling average of team-league rating features for the current team and a current league corresponding to the current team and second rolling average of team-league rating features for the destination team and a destination league corresponding to the destination team; and
generating, by the computing system via a prediction model, a player box score prediction based on the player-position features, the team features, and the rating features, wherein the player box score prediction comprises a plurality of per game metrics of the first player on the destination team.

9. The non-transitory computer readable medium of claim 8, further comprising:
training, by the computing system, the prediction model to generate the player box score prediction by:
generating a training data set, the training data set comprising historical player features and historical team features for a plurality of players and a plurality of teams across a plurality of seasons, and
learning, by the prediction model, relationships between the historical player features and the historical team features.

10. The non-transitory computer readable medium of claim 9, further comprising:
comparing, by the computing system, a predicted set of box score data for each player of the plurality of players to actual box score data; and
based on the comparing, adjusting, by the computing system, one or more parameters of the prediction model.

11. The non-transitory computer readable medium of claim 8, wherein generating, by the computing system, the team features corresponding to the first player comprises:
accessing raw team data for the destination team;
determining that the destination team has not played at least a threshold amount of minutes in the destination league; and
based on the determining, adjusting the raw team data based on an average performance of teams in the destination league.

12. The non-transitory computer readable medium of claim 8, wherein generating, by the computing system, the player-position features corresponding to the first player comprises:
accessing raw player data for the first player in the destination league;
determining that the first player has not played at least a threshold amount of minutes in the destination league; and
based on the determining, adjusting the raw player data based other player data on the destination team that play a same position as the first player.

13. The non-transitory computer readable medium of claim 8, further comprising:
determining, by the computing system, that the first player has played a new game; and
based on the determining, updating, by the computing system, the player-position features, the team features, and the rating features based on metrics associated with the new game.

14. The non-transitory computer readable medium of claim 8, wherein the rating features are team and player rating features.

15. A system comprising:
a processor; and
a memory having programming instructions stored thereon, which, when executed by the processor, causes the system to perform operations comprising:
receiving a request to project a performance of a first player from a current team on a destination team;
based on the request, generating player-position features corresponding to the first player, wherein the player-position features comprise a rolling average of historical player performance data of the first player while playing a first position;
generating team features corresponding to the first player, wherein the team features comprise a first rolling average of historical team performance data of the current team and a second rolling average of historical team performance data of the destination team;
generating rating features for the first player, wherein the rating features comprise a first rolling average of team-league rating features for the current team and a current league corresponding to the current team and second rolling average of team-league rating features for the destination team and a destination league corresponding to the destination team; and
generating, via a prediction model, a player box score prediction based on the player-position features, the team features, and the rating features, wherein the player box score prediction comprises a plurality of per game metrics of the first player on the destination team.

16. The system of claim 15, wherein the operations further comprise:
training the prediction model to generate the player box score prediction by:
generating a training data set, the training data set comprising historical player features and historical team features for a plurality of players and a plurality of teams across a plurality of seasons, and
learning, by the prediction model, relationships between the historical player features and the historical team features.

17. The system of claim 16, wherein the operations further comprise:
comparing a predicted set of box score data for each player of the plurality of players to actual box score data; and
based on the comparing, adjusting one or more parameters of the prediction model.

18. The system of claim 15, wherein generating the team features corresponding to the first player comprises:
accessing raw team data for the destination team;
determining that the destination team has not played at least a threshold amount of minutes in the destination league; and
based on the determining, adjusting the raw team data based on an average performance of teams in the destination league.

19. The system of claim 15, wherein generating the player-position features corresponding to the first player comprises:
accessing raw player data for the first player in the destination league;
determining that the first player has not played at least a threshold amount of minutes in the destination league; and
based on the determining, adjusting the raw player data based other player data on the destination team that play a same position as the first player.

20. The system of claim 15, wherein the operations further comprise:
determining that the first player has played a new game; and
based on the determining, updating the player-position features, the team features, and the rating features based on metrics associated with the new game.
